(19) United States
(12) Patent Application Publication
(10) Pub. No.: US 2016/0014062 A1
(43) Pub. Date: Jan. 14, 2016

(54) SYSTEM AND METHOD FOR BLOCKING OR DELAYING NOTIFICATIONS ON A MOBILE DEVICE WHILE SIMULTANEOUSLY ALLOWING APPROVED INTEGRATED FUNCTIONALITY

(71) Applicant: Rinkesh Patel, Edison, NJ (US)

(72) Inventor: Rinkesh Patel, Edison, NJ (US)

(21) Appl. No.: 14/326,007

(22) Filed: Jul. 8, 2014

(51) Int. Cl. H04L 12/58; G06F 3/16; H04L 29/08

(52) U.S. Cl. CPC H04L 51/12; H04L 51/24; H04L 67/32; G06F 3/165

(57) ABSTRACT

Embodiments of the present invention are generally directed towards systems and methods for altering operation of a mobile computing device. Specifically, embodiments of the present invention are directed to providing systems and methods for blocking or delaying notifications on a mobile device while simultaneously allowing approved integrated functionality. Preferred embodiments of the present invention are directed to blocking or limiting notifications received on a mobile computing device, such as a smartphone, associated with text messages, entails, calls or other alerts during activities where the operation of a mobile device is not safe or desirable (e.g., during operation of a vehicle).

### FIELD OF THE INVENTION

Embodiments of the present invention are generally directed towards systems and methods for altering operation of a mobile computing device. Specifically, embodiments of the present invention are directed to providing systems and methods for blocking or delaying notifications on a mobile device while simultaneously allowing approved integrated. functionality. Preferred embodiments of the present invention are directed to blocking or limiting notifications received on a mobile computing device, such as a smartphone, associated with text messages, emails, calls or other alerts during activities where the operation of a mobile device is not safe or desirable (e.g., during operation of a vehicle).

### BACKGROUND

Mobile device usage has become ubiquitous in modern society. With perpetual connectivity, mobile devices provide users with real-time updates from any number of services, including, but not limited to, emails, text messages, phone calls, voice mails, social media updates or any combination thereof.

Receipt of These updates, or notifications of these updates, are a constant distraction. While not generally an issue, there are times when these distractions are unwanted or even dangerous. For instance, the distraction provided by a mobile device during operation of a motor vehicle has been the result of numerous motor vehicle accidents, collisions and other events causing injury and death to an ever growing number of individuals.

While campaigns for individuals to stop utilizing these mobile devices during operation of motor vehicles or during other hazardous activities, usage persists as the desire to remain ever connected becomes more and more engrained in our daily lives. Further, many jurisdictions have provided legal ramifications for utilizing mobile devices during the operation of motor vehicles and engaging in hazardous activities that may require performance without distraction. Still, individuals persist in using their mobile devices during these activities.

Given that individuals often respond better to instant rewards and gratification rather than a possibility of a negative action occurring, it would be beneficial to have a system and/or method whereby individuals were rewarded for not taking actions related to these notifications at times when such interaction with a mobile device would otherwise be hazardous. Further, since not all functionalities of a mobile computing device are necessarily distracting or otherwise hazardous during certain activities, such as operation of a vehicle, it would be desirable to allow for permissible or integrated functionalities to continue while blocking or delaying other functionalities.

Therefore, there is need in the art for systems and methods for blocking or delaying notifications on a mobile device while simultaneously allowing approved integrated functionality. These and other features and advantages of the present invention will be explained and will become obvious to one skilled in the art through the summary of the invention that follows.

### SUMMARY OF THE INVENTION

Accordingly, it is an aspect of the present invention to systems and methods for blocking or delaying notifications on a mobile device while simultaneously allowing approved integrated functionality.

According to an embodiment of the present invention, a system for blocking or delaying notifications on a mobile device while simultaneously allowing approved integrated functionality includes: a notification blocker module, comprising computer-executable code stored in non-volatile memory, an integrated service module, comprising computer-executable code stored in non-volatile memory, a communications module, a processor, one or more storage mediums, wherein said notification blocker module, said integrated service module, said communications module, said processor, and said one or more storage mediums are operably connected and are configured to: block one or more notifications received on said mobile device; and provide one or more integrated services via said integrated service module.

According to an embodiment of the present invention, the notification blocker module, the integrated service module, said communications module, said processor, and said one or more storage mediums are further configured to: store information related to said one or more notifications; and display said one or more notifications to a display element of said mobile device only upon termination of a blocking process associated with said notification blocker module.

According to an embodiment of the present invention, the notification blocker module, said integrated service module, said communications module, said processor, and said one or more storage mediums are further configured to display a counter on a display element of said mobile device, wherein said counter is a graphical display of a total number of notifications blocked.

According to an embodiment of the present invention, the notification blocker module, said integrated service module, said communications module, said processor, and said one or more storage mediums are further configured to: receive a pass-through notification, wherein said pass-through notification is distinguished from said one or more notifications via an identifier associated with a sender of said pass-through notification and wherein said notification blocker module is configured to allow pass-through notifications associated with said identifier; and provide said pass-through notification to a user of said mobile device.

According to an embodiment of the present invention, the notification blocker module, said integrated service module, said communications module, said processor, and said one or more storage mediums are further configured to: transmit blocked notification information to a remote computing system; and receive, from said remote computing system, one or more rewards associated with said blocked notification information.

According to an embodiment of the present invention, at least one of said one or more integrated services is a global positioning system service configured to provide mapping and location based services to said mobile device while said notification blocker module is engaged.

According to an embodiment of the present invention, at least one of said one or more integrated services is a music provision service configured to provide audio playback to said mobile device while said notification blocker module is engaged.

According to an embodiment of the present invention, the audio playback is selected from the group comprising, audio playback of audio files stored on said one or more storage mediums, audio playback of streaming content received via said communications module and audio playback of audio content received via said communications module.

According to an embodiment of the present invention, a method for blocking or delaying notifications on a mobile device while simultaneously allowing approved integrated functionality includes the steps of: blocking one or more notifications received on said mobile device by way of a notification blocker module; and providing one or more integrated services via an integrated service module.

According to an embodiment of the present invention, the method further includes the steps of: storing information related to said one or more notifications; and displaying said one or more notifications to a display element of said mobile device only upon termination of a blocking process associated with said notification blocker module.

According to an embodiment of the present invention, the method further includes the step of displaying a counter on a display element of said mobile device, wherein said counter is a graphical display of a total number of notifications blocked.

According to an embodiment of the present invention, the method further includes the steps of: receiving a pass-through notification, wherein said pass-through notification is distinguished from said one or more notifications via an identifier associated with a sender of said pass-through notification and wherein said notification blocker module is configured to allow pass-through notifications associated with said identifier; and providing said pass-through notification to a user of said mobile device.

According to an embodiment of the present invention, the method further includes the steps of: transmitting blocked notification information to a remote computing system; and receiving, from said remote computing system, one or more rewards associated with said blocked notification information.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a system diagram, in accordance with an embodiment of the present invention;

FIG. 3 illustrates a system diagram, in accordance with an embodiment of the present invention;

FIG. 4A illustrates a schematic of a system for blocking or delaying notifications on a mobile device while simultaneously allowing approved integrated functionality, in accordance with an embodiment of the present invention;

FIG. 4B illustrates a schematic of a system for blocking or delaying notifications on a mobile device while simultaneously allowing approved integrated functionality, in accordance with an embodiment of the present invention;

FIG. 5 is a process flow of an exemplary method in accordance with embodiments of the present invention;

FIG. 6 is a process flow of an exemplary method in accordance with embodiments of the present invention; and

FIG. 7 is an exemplary embodiment of certain graphical user interfaces (GUIs) provided by the system, in accordance with embodiments of the present invention.

### DETAILED SPECIFICATION

Embodiments of the present invention are generally directed towards systems and methods for altering operation of a mobile computing device. Specifically, embodiments of the present invention are directed to providing systems and methods for blocking or delaying notifications on a mobile device while simultaneously allowing approved integrated functionality. Preferred embodiments of the present invention are directed to blocking or limiting notifications received on a mobile computing device, such as a smartphone, associated with text messages, emails, calls or other alerts during activities where the operation of a mobile device is not safe or desirable (e.g., during operation of a vehicle).

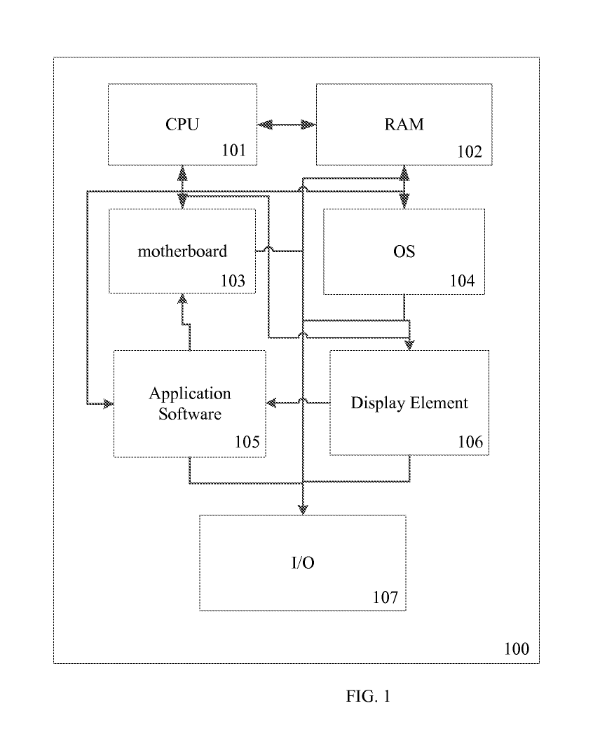

According to an embodiment of the present invention, the system and methods described herein may be accomplished through the use of one or more mobile computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory) 103, an operating system (OS) 104, one or more application software 105, one or more display elements 106 and one or more input/output devices/means 107. Examples of computing devices usable with embodiments of the present invention include, but are not limited to, smartphones, mobile computing devices and tablet PCs. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet, cellular data networks). In accordance with the previous embodiment, the system may receive data from one or more servers or other computing devices communicatively connected across one or more LANs and/or WANs. One of ordinary skill in the art would appreciate that there are numerous manners in which the system could connected and configured to receive and transmit (where applicable) data and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

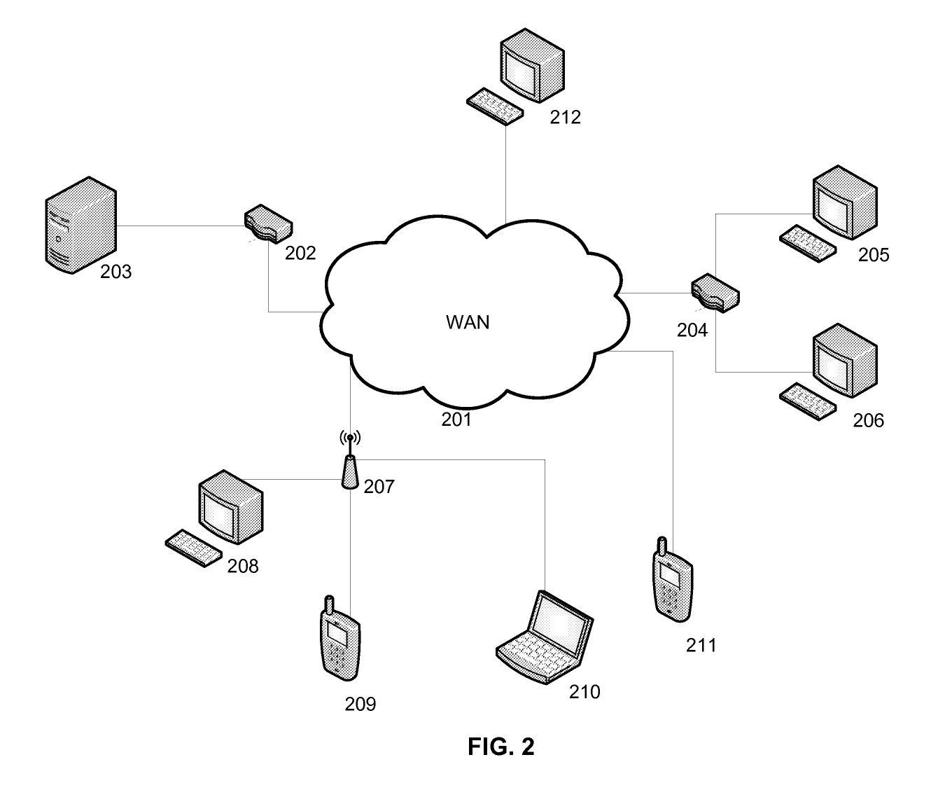

Referring to FIG. 2, a schematic overview of a system in accordance with an embodiment of the present invention is shown. Connection to such networks may be required or desirable for mobile computing device 211 to receive data from any number of sources required for generation of the user interface in accordance with embodiments of the present invention. According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information with the mobile computing device 211 or with other computing devices for use with embodiments of the system, and embodiments of the present invention are contemplated for use with any method for connecting to networks for the purpose of exchanging information. Further, while this application refers to high speed connections, embodiments of the present invention may be utilized with connections of any speed.

For certain embodiments of the present invention, a mobile computing device 211 may connect to one or more data servers 203 or other remote computing components via Network 201 or other network in numerous ways. One of ordinary skill in the art would appreciate that there are numerous ways that a mobile computing device 211 may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

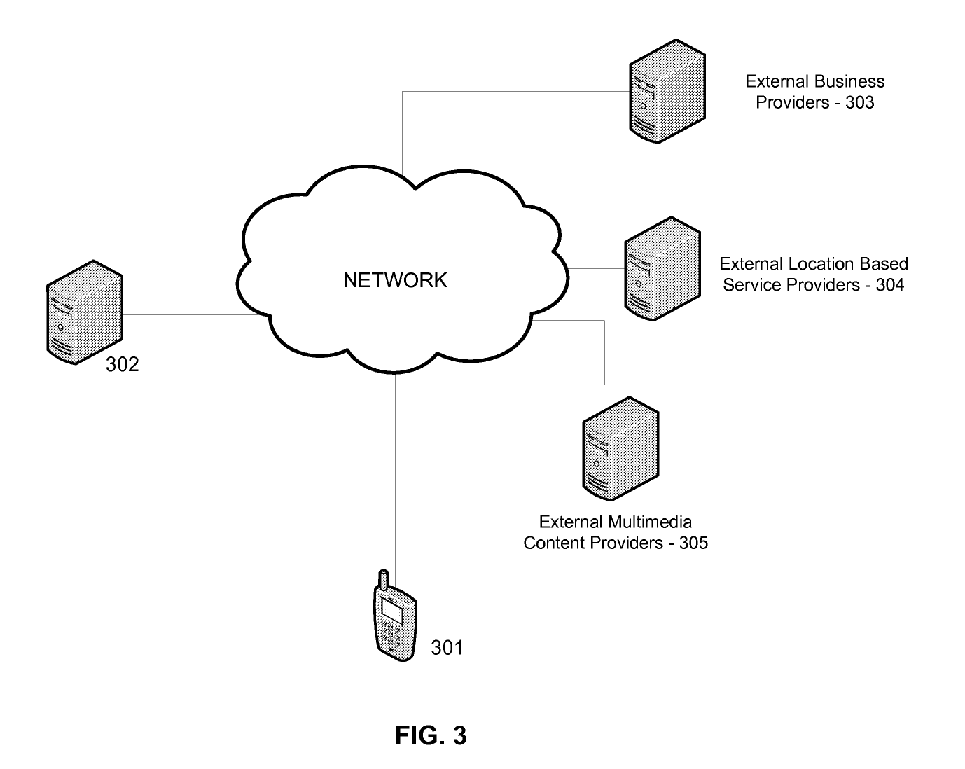

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to application server 302. Application server 302 may be able to enhance or otherwise provide additional services to the user by transmitting and receiving information from one or more of an external business provider API/website or other third party system 303, an external location based service provider 304, an external multimedia content provider 305 or any combination thereof. Additionally, application server 302 may be able to enhance or otherwise provide additional services to the mobile computing device of a user utilizing the API/website or other third party system 303, an external location based service provider 304, an external multimedia content provider 305 by providing information to those entities that is stored on a database that is connected to the application server 302. One of ordinary skill in the art would appreciate how accessing one or more third-party systems could augment the ability of the system described herein, and embodiments of the present invention are contemplated for use with any third-party system.

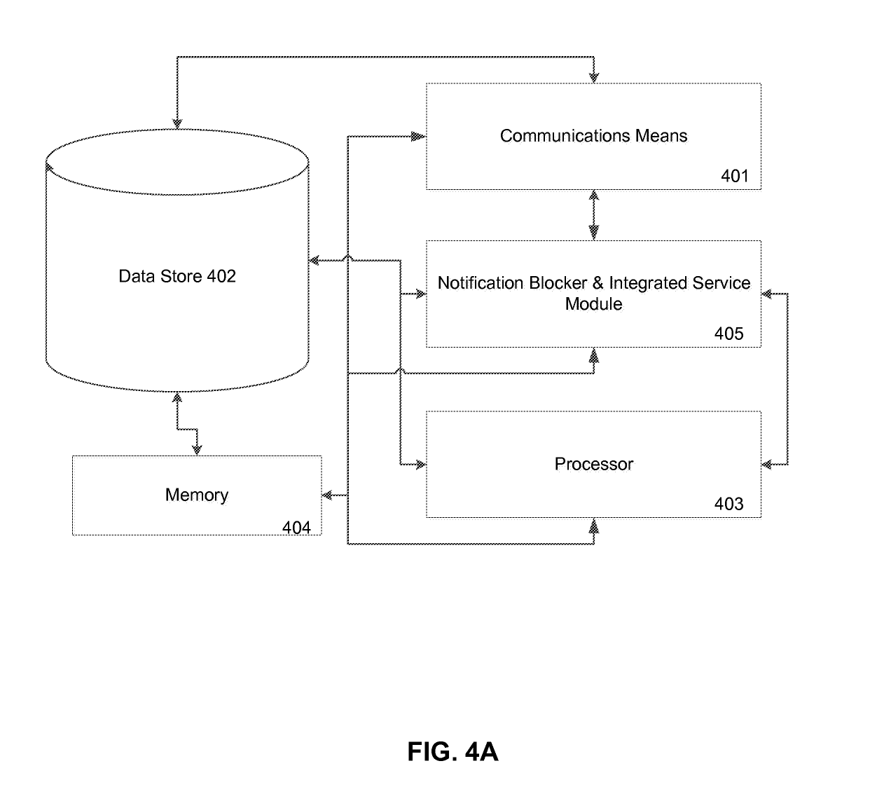

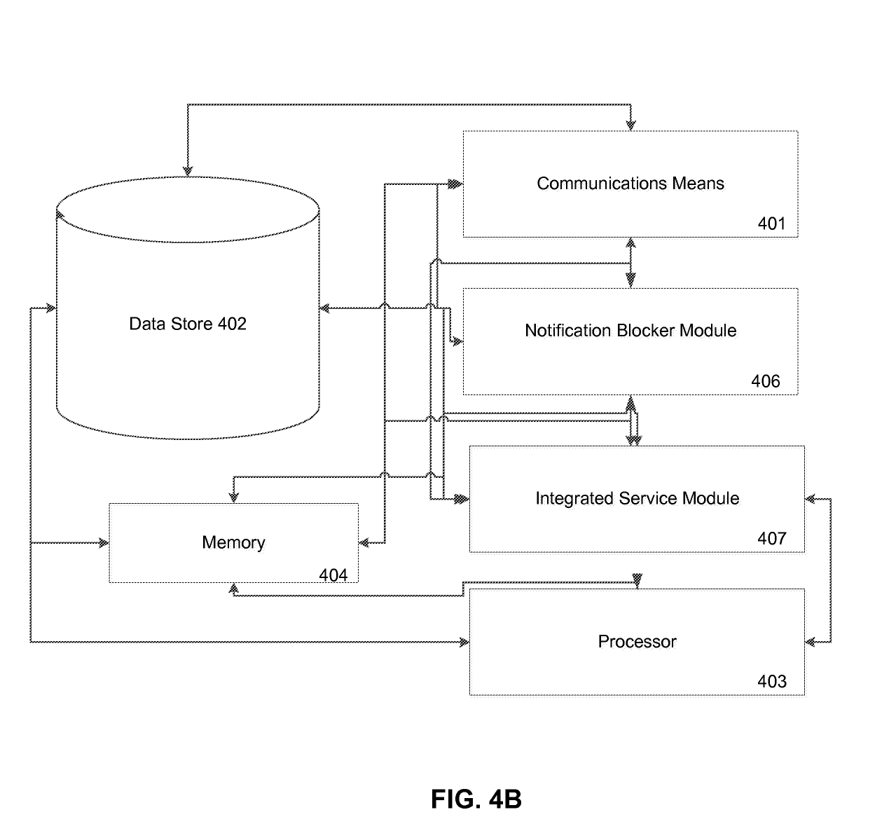

Turning to FIG. 4A, according to an embodiment of the present invention, a system for providing blocking or delaying notifications on a mobile device while simultaneously allowing approved integrated functionality is comprised of one or more communications means 401, one or more data stores 402, a processor 403, memory 404, and a notification blocker and integrated service module 405. In FIG. 4B, according to an embodiment of the present invention, a system for blocking or delaying notifications on a mobile device while simultaneously allowing approved integrated functionality is comprised of one or more communications means 401, one or more data stores 402, a processor 403, memory 404, a notification blocker module 406, and an integrated service module 407. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data over one or more networks. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

According to an embodiment of the present invention, the display element of the system may be, for instance, any type of display that is capable of displaying information to a user. In some embodiments, the display element may also be used as a user interface through which a user both receives information and enters information about a review. In a preferred embodiment, the system is configured to display and collect feedback through a user interface presented on a display element, such as a screen of a smartphone or tablet PC. Display elements may include, but are not limited to, e-ink screens, heads-up displays (e.g., presented on wearable display elements such as glasses), wearable displays (e.g., watches), smartphone displays, tablet PC displays, or any combination thereof. One of ordinary skill in the art would appreciate that there are numerous display elements that might be utilized with embodiments of the present invention, and embodiments of the present invention are contemplated for use with any display element.

According to an embodiment of the present invention, the notification blocker module is configured to prevent notifications, alerts or other audible, visual, or other types of perceptible notifications from being delivered to output components of a mobile device. Output components include, but are not limited to, speakers, headsets, indicator lights, display elements, output ports, interface ports, or any combination thereof. The purpose of blocking (or in some cases, delaying) notifications from being delivered to the output components is to eliminate distractions caused by the usage of a mobile device during certain situations. As such, the notification blocker module is configured to allow for the blocking procedures to be turned on and off, both manually and, in certain cases, automatically.

The notification blocker module can be configured to effect the blocking of notifications in one or more manners. In certain embodiments, the notification blocker module can work in conjunction with the underlying system software of the mobile computing device in order to prevent the utilization of any notification means (e.g., output components) of the mobile computing device from operating in response to a generally received notification. For instance, an application or other service or component generating a notification generally engages the operating system or other system software to utilize the functionality of the underlying hardware of the mobile computing device for provision of a notification. The notification blocker module can be integrated with or work in conjunction with the operating system or other system software to prevent a notification generated by an application or service from actually being provided to one or more output components.

In another embodiment, engagement of the notification blocker module may provide control over and access to each of the appropriate notification means. In this manner, other applications attempting to utilize the notification means will find those means unavailable for issuance of new notifications.

In another embodiment, the notification blocker module may be registered with the operating system or other system software as an independent output means and submit itself in lieu of any other alternative notification means available to the system. In this manner, the notification blocker module will be the recipient of all notifications from the mobile computing device and any application or other service on the mobile computing device. The notification blocker module may then determine how to handle each notification as it arrives, allowing for embodiments of the present invention to dictate how notifications are provided to the user or whether they are delayed, allowed or altogether blocked. One of ordinary skill in the art would appreciate that there are numerous methods and manners in which the notification blocker module could be incorporated onto or into a mobile computing device/mobile device for the purpose of blocking notifications, and embodiments of the present invention are contemplated for use with any appropriate configuration.

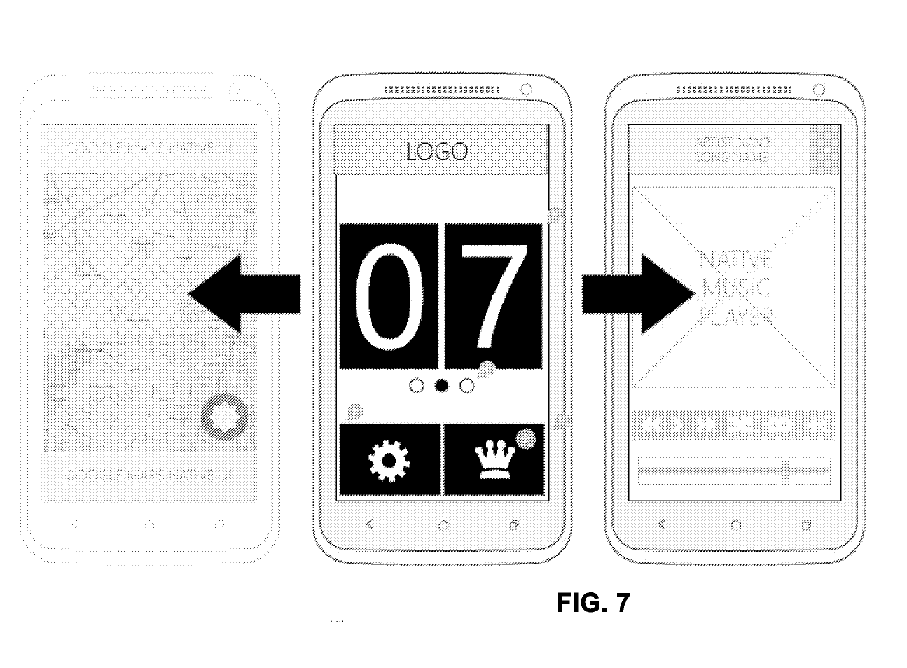

According to an embodiment of the present invention, the notification blocker module may store or otherwise delay notifications received during active blocking of notifications so that these notifications may be delivered at a later time, generally after deactivation of the notification blocking system. During operation, certain embodiments of the present invention may provide a counter or other visual representation of the number of notifications blocked during operation. For instance, the display element of the mobile device may present a GUI showing the number of notifications blocked during the current session (See, FIG. 7, center view). In other embodiments, the GUI may be configured to display other relevant information, such as total number of notifications blocked over a period of time or over the lifetime of usage or the total time the blocker has been active. One of ordinary skill in the art would appreciate that there are numerous types of information that could be displayed on the GUI, and embodiments of the present invention are contemplated for use with display of any relevant information.

According to an embodiment of the present invention, the notification blocker module may be configured to allow for a limited number of notifications to pass through without being blocked or delayed. These pass-through notifications are generally limited to emergency or otherwise important notifications. In certain embodiments, the pass-through notifications may be limited to emergency notifications, such as calls from police or receipt of warnings related to hazards or other conditions in the area that could be dangerous. In other embodiments, the user may be allowed to configure the pass-through notifications by selecting a limited number of individuals (e.g., contacts saved in the mobile device) that should be allowed to notify the user even during active blocking of notifications. This allows for the user to receive important notifications, such as calls from parents, co-workers, clients or others of importance to the individual, while still blocking the notifications from others.

According to an embodiment of the present invention, the notification blocker module may further be configured to allow for the recording and or transmission of automated limited responses to those individuals associated with the important notifications list. The automated limited response may be in the form of a canned response, such as a notification to the individual that the user of the mobile device is currently engaged in an activity that limits his ability to respond to such notifications. In other embodiments, upon receipt of an important notification, the notification blocker module may prompt the user or otherwise allow the user to provide a brief response (e.g., audio response, video response) that will be transmitted to the individual who provided the important notification. For example, upon receiving an important notification, the notification blocker may use an audio output to notify the user of the mobile device that an important notification has been received from a particular individual and that the mobile device will record the next 5 seconds of audio (and/or video) that will be transmitted to the individual. In this manner, the notification blocker provides a pathway for the mobile device to allow important notifications to get to the user of the mobile device and a hands-free pathway for responding to such important notifications. One of ordinary skill in the art would appreciate that there are numerous methods for allowing responses to important notifications allowed by the notification blocker module, and embodiments of the present invention are contemplated for use with any appropriate method for allowing such responses.

According to an embodiment of the present invention, the notification blocker module may further be configured to allow for automated transmission of responses to all individuals based on preconfigured or prepared auto-responses. For example, upon receipt of a notification (e.g., email), the system could reply to the sender of the notification with a canned response noting that the individual using the system is currently engaged in an activity that precludes or restricts the individual's ability to respond. One of ordinary skill in the art would appreciate that there are numerous methods for providing automated responses by the notification blocker module, and embodiments of the present invention are contemplated for use with any appropriate method for providing automated responses.

According to an embodiment of the present invention, the integrated service module is configured to allow for the provision of certain services to the user of a mobile computing device, even when the notification blocker module is actively preventing notifications in general. The purpose of the integrated service module is to provide functionality to a user based on an identified set of services that are allowable based on the type of activity engaged in by the user of the mobile computing device. For instance, if a user is operating a motor vehicle, the integrated service module may be configured to allow for integrated global positioning system (GPS) or other location based services (LBS) to continue to provide functionality to the user of the mobile device. Other allowable integrated services may include, but are not limited to, music provision modules, multimedia content provision modules, emergency service modules, user identified service modules, or any combination thereof. One of ordinary skill in the art would appreciate that there are numerous modules that could be allowed for use by the integrated service module, and embodiments of the present invention are contemplated for use with any appropriate service module.

In preferred embodiments, the system is configured to provide music and GPS/LBS services directly through integrated components. (See, FIG. 7, left and right GUI views). These components may interact with remote services for the provision of data (e.g., GPS location data, map data, music files, streaming audio) or they may utilize data stored on the mobile device, or some combination of the two.

The integrated GPS service may be configured to receive input from a user during active notification blocking usage. Input can be in the way of voice commands received over an appropriate input means (e.g., microphone on the mobile computing device, microphone on a Bluetooth headset, microphone integrated into a car audio system connected to the mobile computing device via a Bluetooth headset). In other embodiments, input to the integrated GPS service may be received through touch or other interactive input means associated with the mobile computing device. For example, FIG. 7 shows how one could move from a blocked notification counter GUI to a GPS GUI via swiping to the left. One of ordinary skill in the art would appreciate that there are numerous methods for receiving input on a mobile computing device, and embodiments of the present invention are contemplated for use with any appropriate input method and means.

According to an embodiment of the present invention, the integrated music service may be configured to provide playback of audio from a variety of sources. For instance, the integrated music service may: (i) playback audio files stored on a storage medium of the mobile computing device; (ii) playback audio received via a streaming music source (e.g., satellite radio transmission, Internet radio transmission, radio transmission); (iii) playback audio received via a music service provider (e.g., SPOTIFY®, ITUNES®); or (iv) any combination thereof. One of ordinary skill in the art would appreciate that there are numerous audio sources that the integrated music service could receive audio files or data for playback from, and embodiments of the present invention are contemplated for use with any appropriate audio source.

According to an embodiment of the present invention, the integrated music service may be configured to playback audio via one or more output means. For instance, the integrated music source could provide audio output to: (i) an integrated speaker of the mobile device; (ii) a Bluetooth headset communicatively connected to the mobile device; (iii) an attached audio output means (e.g., speaker, headphones, headset); (iv) a car audio system attached via a wired or wireless connection to the mobile device; or (v) any combination thereof. FIG. 7 shows how one could move from a blocked notification counter GUI to an integrated music service GUI via swiping to the right.

According to an embodiment of the present invention, the integrated service module may be configured to allow identify one or more additional services to be allowed to operate when the notification blocker module is active. For instance, the integrated service module may allow for emergency calls to be made when the notification blocker module is active.

In certain embodiments, the determination of what services are allowed may be made by the type of activity engaged in by the user. For instance, if the user of the mobile device is operating a bicycle, the mobile device may allow for a flashlight service to be active during while the notification blocker is active. One of ordinary skill in the art would appreciate that there are numerous activities and services associated with those activities that could be utilized with embodiments of the present invention, and embodiments of the present invention are contemplated for use with any activity and associated services.

In other embodiments, the integrated service module may detect services present on the mobile device and provide a list of allowable services to the user. Certain services would not be allowed under any circumstance, such as social media services, messaging services or other services generally intended to be blocked for the provision of notifications. Other services could be optionally allowed, even during engagement of the notification blocker. Preferably, these other services would be services that have been identified as not providing notifications or other distractions to the user of the mobile device.

According to an embodiment of the present invention, the system may be configured to reward users for engaging the notification blocking portion of the invention during certain activities, such as operating a motor vehicle, bicycle or engaging in hazardous activities that require limited distractions. Rewards may be provided, for instance, based on the duration of utilization, based on the total number of notifications blocked/delayed, based on a distance travelled (e.g., calculated by GPS or LBS modules) while the notification blocker was engaged), or any combination thereof. One of ordinary skill in the art would appreciate that there are numerous methods and metrics that could be utilized for providing rewards on, and embodiments of the present invention are contemplated for use with any appropriate method or metric for providing rewards.

According to an embodiment of the present invention, rewards provided by the system can be virtual rewards, such as ribbons, medals, badges or other tokens or honors for meeting certain criteria or metrics. One of ordinary skill in the art would appreciate that there are numerous types of virtual rewards that could be provided by embodiments of the present invention, and embodiments of the present invention are contemplated for use with any such virtual rewards. Such virtual rewards may be displayed on a central system (e.g., website), on a mobile device, or shared across any number of third-party services (e.g., social media networks).

In other embodiments, rewards can be physical or other monetary or real-world applicable rewards, such as, but not limited to (i) discounts to stores, merchants or other providers of goods or services; (ii) provision of reward point systems similar to credit card reward points or other reward programs offering exchange of points for goods or services; (iii) or any combination thereof. The stores or other providers of rewards may be third-parties or otherwise unrelated to the provider of the system, allowing for other organizations to utilize the reward/award system of the present invention for the purposes of providing rewards in accordance with the methods provided for herein. One of ordinary skill in the art would appreciate that there are numerous types of rewards programs that could be implemented in association with embodiments of the present invention, and embodiments of the present invention are contemplated for use with any appropriate reward program.

According to an embodiment of the present invention, data associated with the system can be utilized in conjunction with certain providers of goods or services to provide altered pricing of their goods or services. For instance, users of a mobile device that have high percentages of blocked notifications may be eligible for reduced insurance rates from participating insurance providers. In this manner, the habits of the mobile device user may be utilized to reward good behavior (or punish bad behavior) with respect to mobile device utilization during motor vehicle operation.

### Exemplary Embodiments

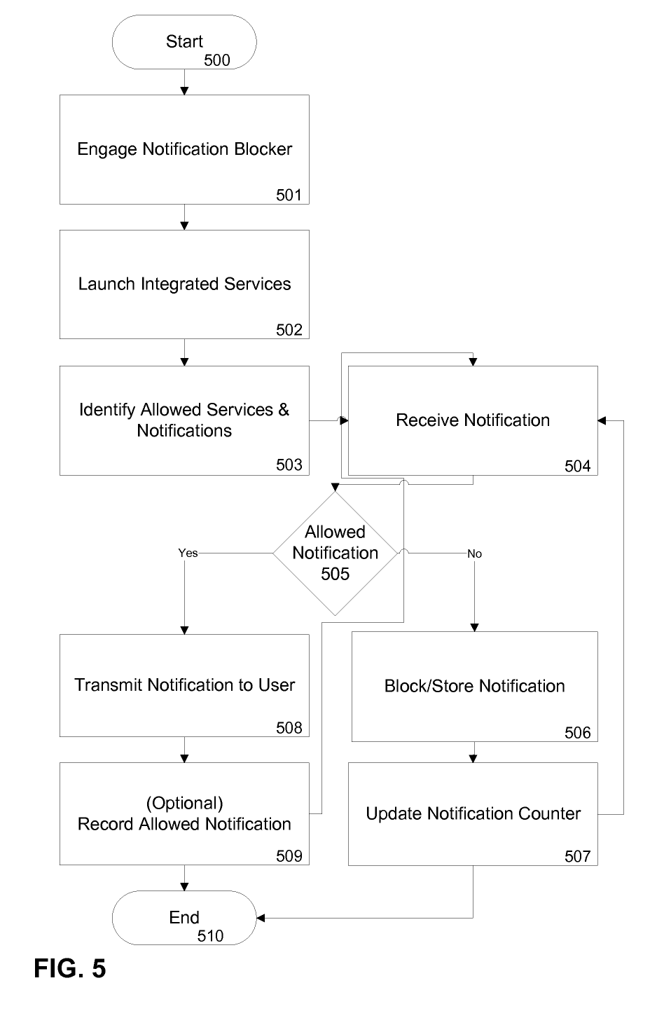

Turning now to FIG. 5, an exemplary method for use provided by the system is shown. The process starts at step 500 with a user of a mobile device requesting the start of the notification blocker. At step 501, the system engages the notification blocker based on preconfigured settings provided to the system prior to engagement of the notification blocker module. Engagement of the notification blocker at this point begins the prevention of notifications from other applications running on the mobile device.

At step 502, any integrated services desired by the user are launched and available for utilization. As discussed above, this may include, but is not limited to, a GPS/LBS service and a music service. These services may allow for interaction and provision of such services as detailed previously herein.

At step 503, the system identifies any other allowed services and/or notifications that will be capable of utilization during the notification blocker's engagement. This may include identification of any individuals allowed to provide important notifications through the regularly blocked notification process. At this point, the system is engaged and ready to begin receiving and blocking or otherwise processing notifications.

At step 504, the system receives a notification. The system then determines if the notification is one that is allowed to pass-through the blocker (step 505).

If the notification is one that is not excepted from general notification blocking, then the notification is blocked and stored for later provision to the user of the mobile device when the notification blocker is disengaged (step 506). At step 507, the notification counter is updated to reflect the receipt and blocking of a notification and the process will terminate at step 510, or continue to loop through notifications (step 504). While not shown, the blocking of notifications may be reported to a remote computing device, such as a server, for recording statistics with respect to allowance and blocking of notifications.

If the notification is one that is excepted from general blocking, the system transmits the notification to the user at step 508. This may be done in accordance with processes previously described herein. Optionally, at step 509, the system will record the provision of the allowed notification. Recording does not necessarily mean that the actual notification is recorded, but rather the fact that a notification was allowed beyond the notification blocker. The allowance of such notifications may effect rewards or other services provided to the user of the mobile device. The recordation of such a notification allowance may be transmitted to a remote computing device, such as a server, for recording statistics with respect to allowance and blocking of notifications. At this point the process will terminate at step 510, or continue to loop through notifications (step 504).

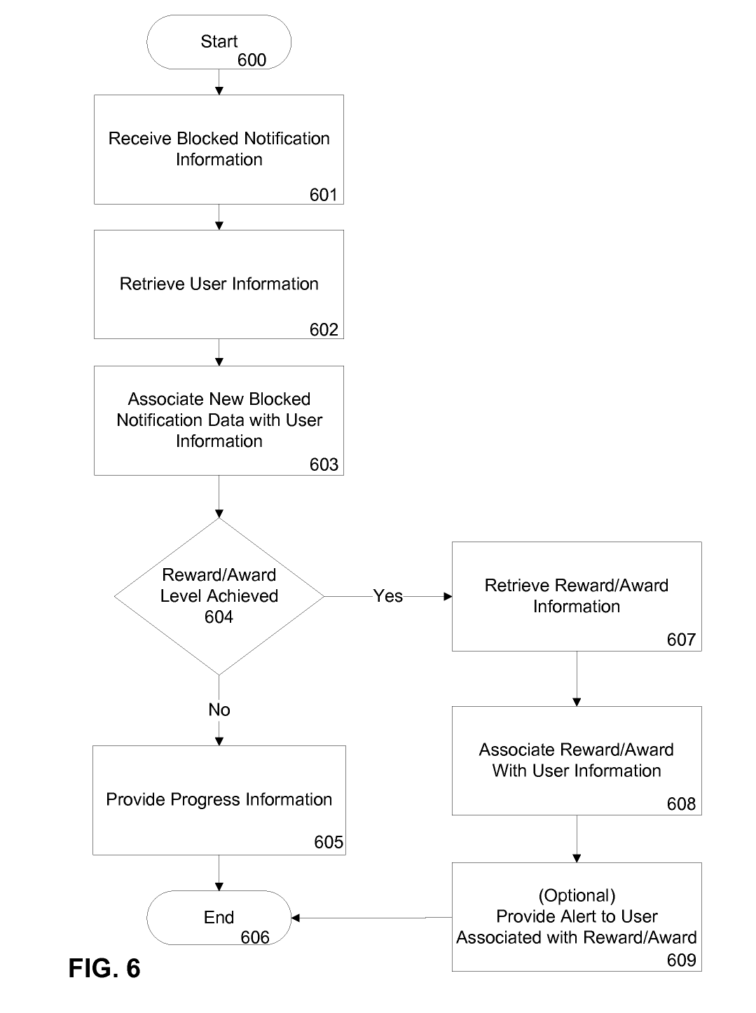

Turning now to FIG. 6, an exemplary method for use provided by the system is shown. The process starts at step 600 with a mobile device providing information to a remote server or other remote computing system for the recordation of blocked notification information. At step 601, the system receives the blocked notification information and sets about processing the blocked notification information.

At step 602, the system retrieves user information associated with the blocked notification information. In a preferred embodiment, the blocked notification information will include a user identifier (e.g., token, user/password combination, cookie) capable of identifying the user. The system will use this user identifier to retrieve stored information about the user.

At step 603, the system associates the blocked notification information with an account or other data associated with the identified user. Information stored may include number of notifications blocked, number of notifications allowed, type of notifications blocked, duration of usage of the notification blocker module, start time, end time, or any combination thereof.

At step 604, the system may determine if the updated information results in a reward or award being reached or available to the user.

If the additional information related to blocked notifications does not qualify the user for any additional rewards or awards, the system may be configured to provide to the mobile device of the user information related to the progress of the user towards the next available reward or award (step 605). At this point the process will terminate at step 606.

If the additional information related to blocked notifications does qualify the user for additional rewards or awards, the system may be configured to retrieve reward/award information (step 607) related to those rewards/awards available to the user. At step 608, the system will associate the earned rewards/awards with the user's account. Optionally, the system may also be configured to provide a notification or alert to the user related to the earned reward/award (step 609). At this point, the process terminates at step 606.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for blocking or delaying notifications on a mobile device while simultaneously allowing approved integrated functionality, the system comprising:
a notification blocker module, comprising computer-executable code stored in non-volatile memory,
an integrated service module, comprising computer-executable code stored in non-volatile memory,
a communications module,
a processor,
one or more storage mediums,
wherein said notification blocker module, said integrated service module, said communications module, said processor, and said one or more storage mediums are operably connected and are configured to:
block one or more notifications received on said mobile device; and
provide one or more integrated services via said integrated service module.

2. The system of claim 1, wherein said notification blocker module, said integrated service module, said communications module, said processor, and said one or more storage mediums are further configured to:
store information related to said one or more notifications; and
display said one or more notifications to a display element of said mobile device only upon termination of a blocking process associated with said notification blocker module.

3. The system of claim 1, wherein said notification blocker module, said integrated service module, said communications module, said processor, and said one or more storage mediums are further configured to display a counter on a display element of said mobile device, wherein said counter is a graphical display of a total number of notifications blocked.

4. The system of claim 1, wherein said notification blocker module, said integrated service module, said communications module, said processor, and said one or more storage mediums are further configured to:
receive a pass-through notification, wherein said pass-through notification is distinguished from said one or more notifications via an identifier associated with a sender of said pass-through notification and wherein said notification blocker module is configured to allow pass-through notifications associated with said identifier; and
provide said pass-through notification to a user of said mobile device.

5. The system of claim 1, wherein said notification blocker module, said integrated service module, said communications module, said processor, and said one or more storage mediums are further configured to:
transmit blocked notification information to a remote computing system; and
receive, from said remote computing system, one or more rewards associated with said blocked notification information.

6. The system of claim 1, wherein at least one of said one or more integrated services is a global positioning system service configured to provide mapping and location based services to said mobile device while said notification blocker module is engaged.

7. The system of claim 1, wherein at least one of said one or more integrated services is a music provision service configured to provide audio playback to said mobile device while said notification blocker module is engaged.

8. The system of claim 7, wherein said audio playback is selected from the group comprising, audio playback of audio files stored on said one or more storage mediums, audio playback of streaming content received via said communications module and audio playback of audio content received via said communications module.

9. A method for blocking or delaying notifications on a mobile device while simultaneously allowing approved integrated functionality, the method comprising the steps of:
blocking one or more notifications received on said mobile device by way of a notification blocker module; and
providing one or more integrated services via an integrated service module.

10. The method of claim 9, further comprising the steps of:
storing information related to said one or more notifications; and
displaying said one or more notifications to a display element of said mobile device only upon termination of a blocking process associated with said notification blocker module.

11. The method of claim 9, further comprising the step of displaying a counter on a display element of said mobile device, wherein said counter is a graphical display of a total number of notifications blocked.

12. The method of claim 9, further comprising the steps of:
receiving a pass-through notification, wherein said pass-through notification is distinguished from said one or more notifications via an identifier associated with a sender of said pass-through notification and wherein said notification blocker module is configured to allow pass-through notifications associated with said identifier; and
providing said pass-through notification to a user of said mobile device.

13. The method of claim 9, further comprising the steps of:
transmitting blocked notification information to a remote computing system; and
receiving, from said remote computing system, one or more rewards associated with said blocked notification information.

14. The method of claim 9, wherein at least one of said one or more integrated services is a global positioning system service configured to provide mapping and location based services to said mobile device while said notification blocker module is engaged.

15. The method of claim 9, wherein at least one of said one or more integrated services is a music provision service configured to provide audio playback to said mobile device while said notification blocker module is engaged.

16. The method of claim 15, wherein said audio playback is selected from the group comprising, audio playback of audio files stored on said one or more storage mediums, audio playback of streaming content received via said communications module and audio playback of audio content received via said communications module.
